(19) United States
(12) Patent Application Publication
(10) Pub. No.: US 2009/0136132 A1
(43) Pub. Date: May 28, 2009

(54) METHOD FOR IMPROVING QUALITY OF IMAGE AND APPARATUS FOR THE SAME

(76) Inventors: Toshiyuki ONO, Kawasaki-shi (JP); Yasunori Taguchi, Kawasaki-shi (JP); Tekeshi Mita, Yokohama-shi (JP); Takashi Ida, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/233,097

(22) Filed: Sep. 18, 2008

(30) Foreign Application Priority Data
Nov. 28, 2007 (JP) 2007-307746

(51) Int. Cl. G06K 9/34; G06K 9/40

(52) U.S. Cl. 382/173; 382/254

(57) ABSTRACT

A method for improving quality of an image includes storing feature quantity candidates each having a luminance component for improving of quality of a first image, dividing the first image into blocks with an overlapping region formed between adjacent first and second blocks, assigning first and second feature quantity candidates selected from the feature quantity candidates of the storage to the first and second blocks, respectively, calculating an energy expressing each similarity between first and second luminance patterns of the first and second feature quantity candidates in the overlapping region, selecting one first feature quantity and one second feature quantity from the first and second feature quantity candidates, using the energy, and improving qualities of the first and second blocks using the first and second feature quantities to generate a second image.

### CROSS-REFERENCE TO RELATED APPLICATIONS

This application is based upon and claims the benefit of priority from prior Japanese Patent Application No. 2007-307746, filed Nov. 28, 2007, the entire contents of which are incorporated herein by reference.

### BACKGROUND OF THE INVENTION

1. Field of the Invention

This invention relates to a method for improving quality of an image and an apparatus for the same.

2. Description of the Related Art

A technique for generating a high quality image by performing processing for increasing resolution or sharpening on an input image of poor quality, for example, a low-resolution image of blurred image attracts attention. W. T. Freeman, E. C. Pasztor, and O. T. Carmichael, “Learning low-level vision”, International Journal of Computer Vision, vol. 40, no. 1, pp. 25-47, 2000 discloses a technique to use, in particular, learning data in such a technology for improving quality of an image.

In this technique, at first, a dictionary is prepared which stores a feature quality necessary for improving quality of an image in a learning stage (for example, a patch representing a high frequency component of an image). Meanwhile, in an image quality improvement stage, a temporal high quality image is created by temporarily improving quality of an input image of low quality, and the temporal high quality image is improved using the feature quantity of the dictionary for each image block.

In image quality improvement, at first, the temporal high quality image is divided into a plurality of blocks so that an overlapping region is formed between adjacent bocks, and plural feature quantities are assigned to each block. Thereafter, an energy function is set which is composed of an energy representing a conformity degree between the first and second feature quantities assigned to adjacent first and second blocks, respectively, and an energy representing a conformity degree of the feature quantity with respect to the temporal high quality image. In this description, the former energy is referred to as an adjacent energy, and the latter energy is referred to as occurrence energy. Next, the first and second feature quantities are selected which are combined so that the energy function is minimum about the entire of the temporal high quality image. The temporary high quality image is improved using the feature quantity selected in this way.

In the technique of W. T. Freeman, E. C. Pasztor, and O. T. Carmichael, the adjacent energy is calculated based on the sum of squared differences (SSD) between the luminance values of the first feature quantity assigned to the first block in the overlapping region and the luminance values of the second feature quantity assigned to the second block in the overlapping region. The adjacent energy calculated in this way indicates a value decreasing as the degree of similarity between the patterns of the first and second feature quantities increases.

However, in the case where a change of the luminance of the feature quantity is small, even if the patterns of the first and second feature quantities are not analogous with each other, the value of the adjacent energy decreases. On this account, as a result, the feature quantity of small luminance change is selected by priority due to energy optimization. Therefore, the effect of image quality improvement is not provided enough.

It is an object of the present invention to enable further improvement of quality of the image by making it possible to select a feature quantity suitable for improvement of quality of the image even if the luminance change of the feature quantity of the image is small.

### BRIEF SUMMARY OF THE INVENTION

An aspect of the present invention provides A method for improving quality of an image comprising: storing plural feature quantity candidates each having a luminance component for improving quality of a first image in a storage; dividing the first image into plural blocks with an overlapping region being formed between a first block and a second block which are adjacent to each other; assigning a set of first feature quantity candidates and a set of second feature quantity candidates which are selected from the plural feature quantity candidates of the storage, to the first block and the second block, respectively; calculating an energy expressing each similarity between first luminance patterns of the first feature quantity candidates in the overlapping region and second luminance patterns of the second feature quantity candidates in the overlapping region; selecting one first feature quantity and one second feature quantity from the first feature quantity candidates and the second feature quantity candidates, using the energy; improving quality of the first block and the second block using the first feature quantity and the second feature quantity to generate a second image.

### BRIEF DESCRIPTION OF THE SEVERAL VIEWS OF THE DRAWING

FIG. 1 is a block diagram illustrating an image quality improvement apparatus according to a first embodiment.

FIG. 2 is a flow chart illustrating an outline of image quality improvement processing in the first embodiment.

FIG. 3 is a schematic diagram illustrating an example of the structure of a feature quantity memory.

FIG. 4 is a schematic diagram for explaining a method for creating data of the feature quantity memory.

FIG. 5 is a flow chart illustrating a feature quantity candidate assigning unit.

FIG. 6 is a flow chart illustrating an adjacent energy calculator.

FIG. 7 is a schematic diagram for explaining arrangement situation of blocks.

FIG. 8A is a schematic diagram for explaining a method for generating an increment sign vector.

FIG. 8B is a schematic diagram for explaining a method for generating an increment sign vector.

FIG. 9 is a flow chart illustrating an operation of carrying out optimization locally in a selector.

FIG. 10 is a flow chart illustrating an operation of carrying out optimization globally in the selector.

FIG. 11 is a block diagram illustrating an image quality improvement apparatus according to a second embodiment.

FIG. 12A is a diagram for explaining a result obtained by improving quality of an image according to the first embodiment.

FIG. 12B is a diagram illustrating a high quality image based on a conventional technique for purpose of explaining a result obtained by improving quality of an image according to the first embodiment.

FIG. 12C is a diagram illustrating a temporal high quality image for explaining a result obtained by improving quality of an image according to the first embodiment.

FIG. 12D is a diagram illustrating an output image for explaining a result obtained by improving quality of an image according to the first embodiment.

### DETAILED DESCRIPTION OF THE INVENTION

There will now be described embodiments of the present invention referring to drawing hereinafter.

### First Embodiment

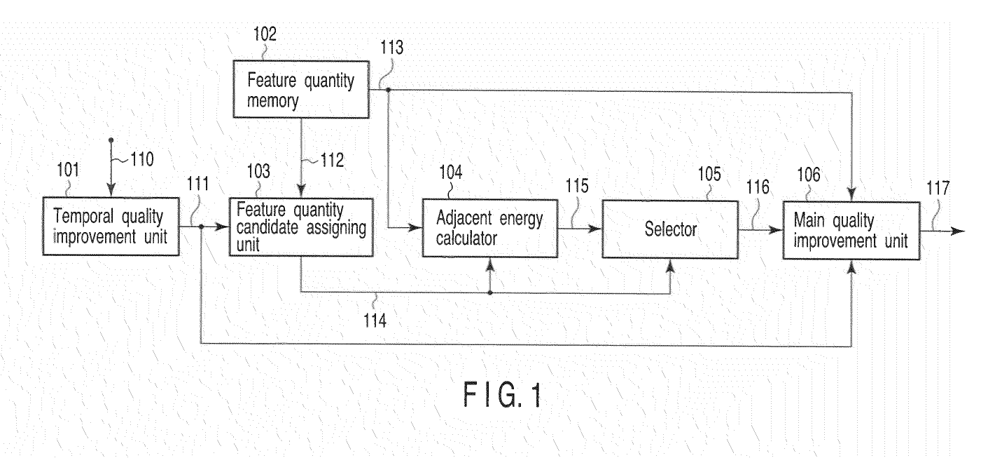

As shown in FIG. 1, the image quality improvement apparatus according to the first embodiment increases a temporal quality improvement unit 101, a feature quantity memory 102, a feature quantity candidate assignment unit 103, an adjacency energy calculator 104, a selector 105 and a main quality improvement unit 106.

The input image 110 of the image quality improvement apparatus is a low quality image, and an output image 117 is generated by improving quality of the input image 110 through the temporal quality improvement unit 101 and the main quality improvement unit 106. The temporal quality improvement unit 101 improves quality of the input image 110 temporarily to generate a temporal high quality image 111. The temporal high quality image 111 is input to the feature quantity candidate assignment unit 103.

The feature quantity candidate assignment unit 103 divides the temporal high quality image 111 into plural blocks, and assigns plural feature quantity candidates for improving quality of the temporal high quality image 111 to each block. As described hereinafter, the image block does not only divide simply the temporal high quality image into plural blocks each having plural pixels, but also divides it into plural blocks so that an overlapping region is formed between adjacent blocks. The processing performed on and after the temporal quality improvement unit 101 is carried out in units of a block. Therefore, the block in processing is called a processing block hereinafter.

The feature quantity for improving quality of the temporal high quality image 111 is stored in the feature quantity memory 102 beforehand. The assignment of the feature quantity candidates which is carried out by the feature quantity candidate assignment unit 103 is done by the assignment of indexes actually. In other words, a feature quantity index 112 indicating a feature quantity read out as a feature quantity candidate from the feature quantity memory 102 is assigned to a processing block of the temporal high quality image 111. As a result, a candidate index 114 indicating a feature quantity candidate assigned to the processing block is output from the feature quantity candidate assignment unit 103.

Feature quantity data 113 indicated by the index 112 is read out together with the feature quantity index 112 from the feature quantity memory 102. This feature quantity data 113 is supplied to the adjacent energy calculator 104. The adjacent energy calculator 104 calculates an energy (referred to as an adjacent energy) indicating each similarity between first and second feature quantity candidates assigned, respectively, to adjacent two blocks, that is, first and second blocks in the overlapping region of the temporal high quality image 111, based on the candidate index 114 from the feature quantity candidate assignment unit 103 and the feature quantity data 113 from the feature quantity memory 102. The adjacent energy information 115 output from the adjacent energy calculator 104 is supplied to the selector 105.

The selector 105 selects one feature quantity from feature quantity candidates assigned to the adjacent two blocks, respectively, according to the adjacent energy. For example, the feature quality by which the adjacent energy comes to be extremely small (preferably minimum) is selected from the feature candidates assigned to the adjacent two blocks. The main quality improvement unit 106 improves quality of the temporary output image 111 by the feature quantity selected with the selector 105 to generate an output image 117.

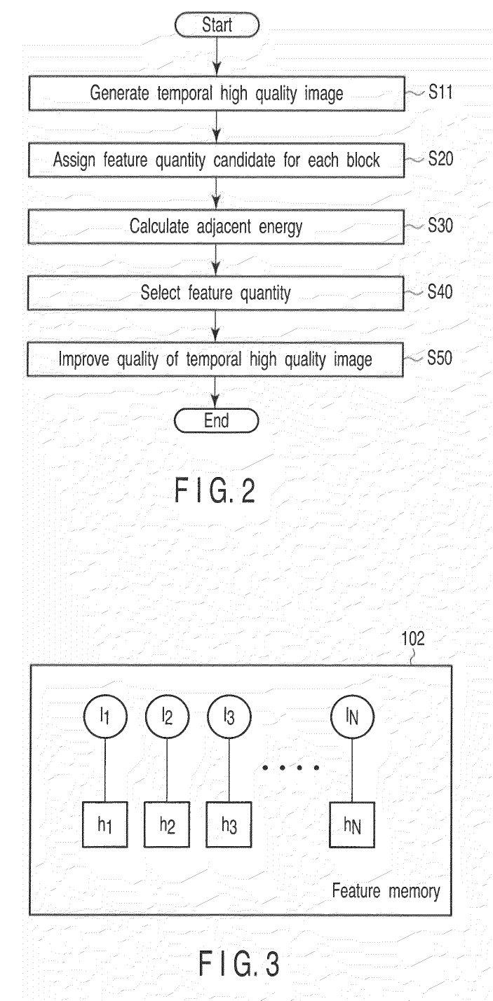

There will be described a flow of a schematic operation of the image quality improvement apparatus of FIG. 1 referring to FIG. 2 hereinafter. In the following description, an example of generating an output of high-resolution by improving the quality of the input image 110 of low-resolution. In addition, the image quality improvement can be embodied for not only realization of high-resolution but also for, for example, debluring a image, elimination of image compression noise and creating high gradation image.

At first, the temporal quality improvement unit 101 makes the input image 110 of low resolution into an image of high-resolution and generates a temporal high quality image 111 that is a temporary high-resolution image (step S11). The processing for high-resolution in step S11 can use interpolation based on the nearest neighbor expansion and the like, the bilinear interpolation method or the cubic convolution interpolation method. The temporal high quality image 111 is input to the feature quantity candidate assignment unit 103.

The feature quantity candidate assignment unit 103 divides the temporal high quality image 111 into blocks, and assigns plural feature quantities selected from the feature quantity memory 102 to each block as feature quantity candidates (step S20).

The adjacent energy calculator 104 calculates an adjacent energy indicating each similarity between the feature quantity candidates assigned to adjacent two blocks of the temporal high quality image 111, respectively (step S30).

The selector 105 determines a combinatorial feature quantity by which the adjacency energy calculated with the adjacent energy calculator 104 comes to be very small, from the feature quantity candidates assigned to each block of the temporal high quality image 111, and outputs a feature quantity index 116 showing those feature quantities (step S40).

Finally, the main quality improvement unit 106 improves quality of the temporal high quality image 110 by the feature quantity selected with the selector 105, that is, the feature quantity indicated by the feature quantity index 116 and stored in the feature quantity memory 102, and generates a high quality output image 117 (step S50).

(Feature Quantity Memory 102)

The feature quantity memory 102 is explained hereinafter. The feature quantities acquired by learning beforehand and used for improving quality of the temporal high quality image 111 are stored in the feature quantity memory 102. FIG. 3 shows an example of the structure of the feature quantity memory 102 schematically.

As shown in FIG. 3, the feature quantity memory 102 stores a pair of a set of plural (N) low quality image feature quantities li(i=1, 2, . . . , N) extracted from the image block of the temporal high quality image 111 and a set of plural feature quantities hi(i=1, 2, . . . , N) for improving the quality of the image block of the temporal high quality image 111.

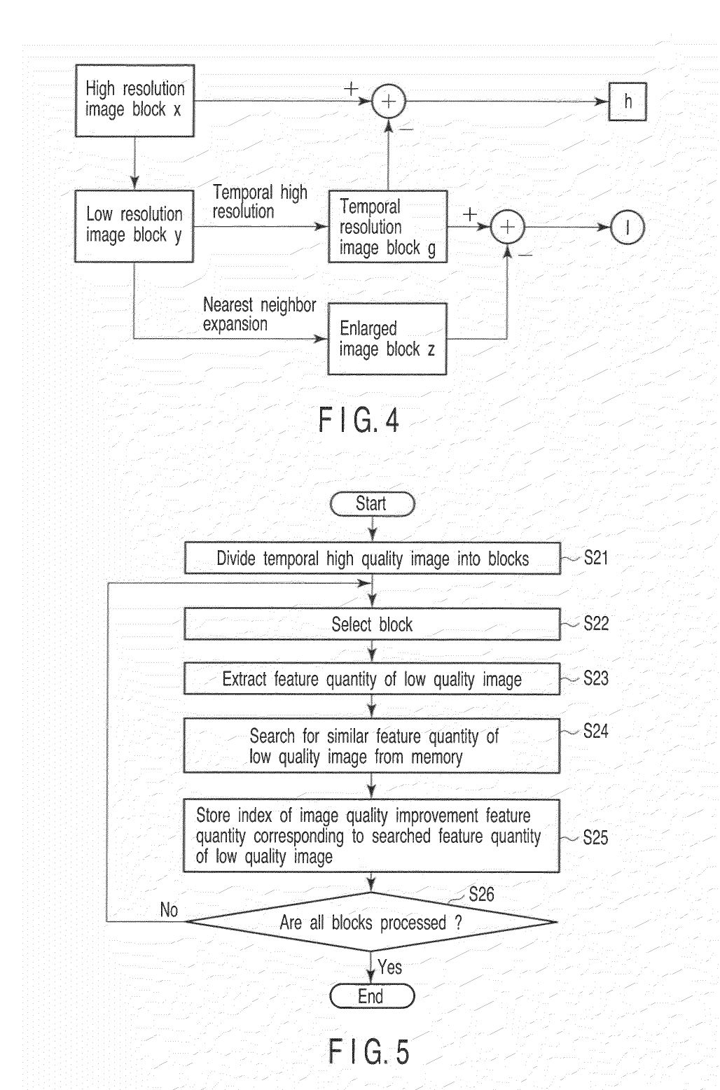

An example of how to make the li-hi pair is explained referring to FIG. 4. A low resolution image block y is generated by once degrading the high-resolution image block x extracted from an image for learning so that it become a picture quality similar to that of the input image 110. Next, the low resolution image block y is subjected to image quality improvement (processing for providing high-resolution) similar to the temporal quality improvement carried out with the temporal quality improvement unit 101 to generate a temporary high-resolution image block g. At the same time, the low resolution image block y is subjected to nearest neighbor expansion to generate an enlarged image z.

Next, the enlarged image z is subtracted from the temporary high definition image block g to generate a low quality image feature quantity 1, and the temporal high resolution image block g is subtracted from the high-resolution image block x to generate an image feature quantity h for image quality improvement. The low quality image feature quantity 1 and feature quantity h for image quality improvement, which are acquired in this way, make one pair. If the pair is formed in this way, the image block g′ is generated by improving temporarily quality of the block extracted from the input image 110, and a high quality/high resolution image is generated by g′+h by selecting a proper h. In addition, the low resolution image block y may be substituted for the low quality image feature quantity 1, and the low resolution image block y having a high correlation with respect to the image feature quantity h for image quality improvement may be selected. In addition, in order to shorten a calculation time and reduce the capacity of the feature quantity memory 102, dimension compression may be carried out using principal component analysis.

As described above, the image feature quantity h for image quality improvement is a high frequency component which is not included in the temporal high quality image 111. According to this embodiment, the image quality improvement such as the high resolution of image and sharpness thereof can be carried out by supplementing information unable to be restored with the temporal quality improvement unit 101 with the feature quantity for image quality improvement. (The feature quantity candidate assignment unit 103)

The feature quantity candidate assignment unit 103 is explained referring to FIG. 5 hereinafter. FIG. 5 shows a detailed processing example of step S20 in FIG. 2.

At first, the feature quantity candidate assignment unit 103 divides the temporal high quality image 111 into blocks (step S21). In this time, the blocks are divided so that they have a region overlapping with each other in the temporal high quality image 111.

One block is selected from plural blocks provided in step S21 as a processing block (step S22). A low quality image feature quantity l_{query} is extracted from the selected block (step S23). The method for generating the low quality image feature quantity l_{query} accords to FIG. 4. In other words, the block selected in step S22 is assumed to be the block g in FIG. 4. The block of the input image at a position corresponding to the block g is assumed to be y. The low quality image feature quantity l_{query} is made by g-z.

One or more low quality image feature quantities li similar to the low quality image feature quantity l_{query} extracted in step S24 are searched for from the feature quantity memory 102 (step S24). In other words, the feature quantity of the low quality image feature quantities which indicates the maximum similarity with respect to the low quality image feature quantity l_{query}, or some feature quantities in order of decreasing similarity are searched for from the feature quantity memory 102. In this case, the similarity can use a distance ∥lᵢ-l_{query}∥ between the low quality image feature quantity l_{query} extracted in step S24 and the low quality feature quantity li in the feature quantity memory 102.

The indexes 114 of all high quality feature quantities hi for image quality improvement corresponding to one or more low quality image feature quantities lᵢ searched for in step S24 are read out and recorded (step S25).

The process of steps S21 to S25 is repeated till it is determined that all blocks have been processed, and the processing of the feature quantity candidate assignment unit 103 is finished.

(The Adjacent Energy Calculator 104)

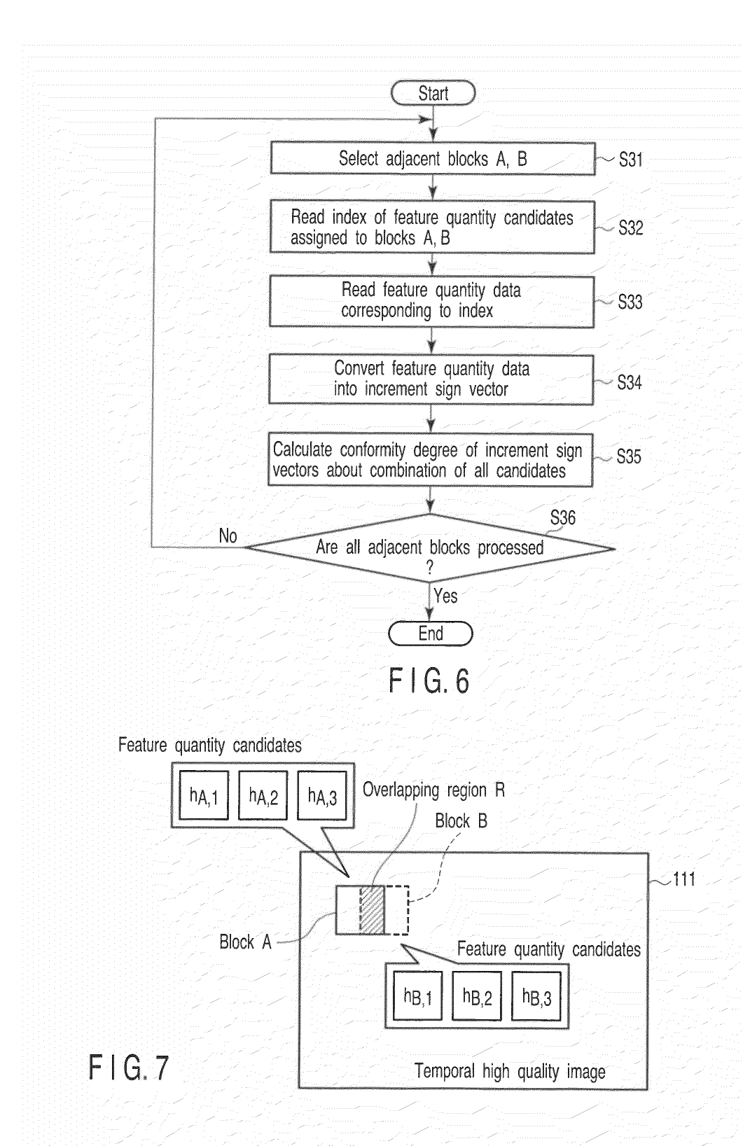

The processing of the adjacent energy calculator 104 is explained referring to FIG. 6 hereinafter. FIG. 6 shows a concrete processing example of step S30 of FIG. 2. At first, two adjacent blocks (for example, A and B) are selected (step S31).

The candidate indexes 114 indicating feature quantity candidates assigned to selected two blocks A and B respectively are read out from the feature quantity candidate assignment unit 103 (step S32), and the feature quantity data 113 corresponding to the candidate indexes 114 is read out from the feature quantity memory 102 (step S33).

NA feature quantity data elements read about the block A are assumed to be {h_{A,1,} h_{A,2,} . . . , h_{A,NA}}, and NB feature quantity data elements read about the block B are assumed to be {h_{B,1}, h_{B,2}, . . . , h_{B,NB}}.

The feature quantity data elements {h_{A,1}, h_{A,2}, . . . , h_{A,NA}} and {h_{B,1}, h_{B,2}, . . . , h_{B,NB}} are converted into the increment sign vector (step S34).

For ease of explanation, an example based on the following condition will be described. When the feature quantity candidate assignment unit 103 divides the temporal high quality image 111 into blocks, the block size is 8*8 pixels, and all the blocks are arranged so as to have overlapping regions which overlap four pixels in horizontal and vertical directions respectively. Furthermore, it is assumed that the blocks A and B are adjacent to right and left. The size of the block and the size and shape of the overlapping region that are shown here are an example, and discretionary.

The blocks A and B have the overlapping region R of four pixels in the horizontal direction and eight pixels in the vertical direction as shown in a dashed line in FIG. 7. About this overlapping region R, the adjacent energy can be calculated by calculating each similarity between the spatial luminance patterns of the feature quantity candidates assigned to the blocks A and B. The above description explains an example wherein the blocks A and B are adjacent in the horizontal direction, but ever if they are adjacent in the vertical direction, the adjacent energy can be calculated.

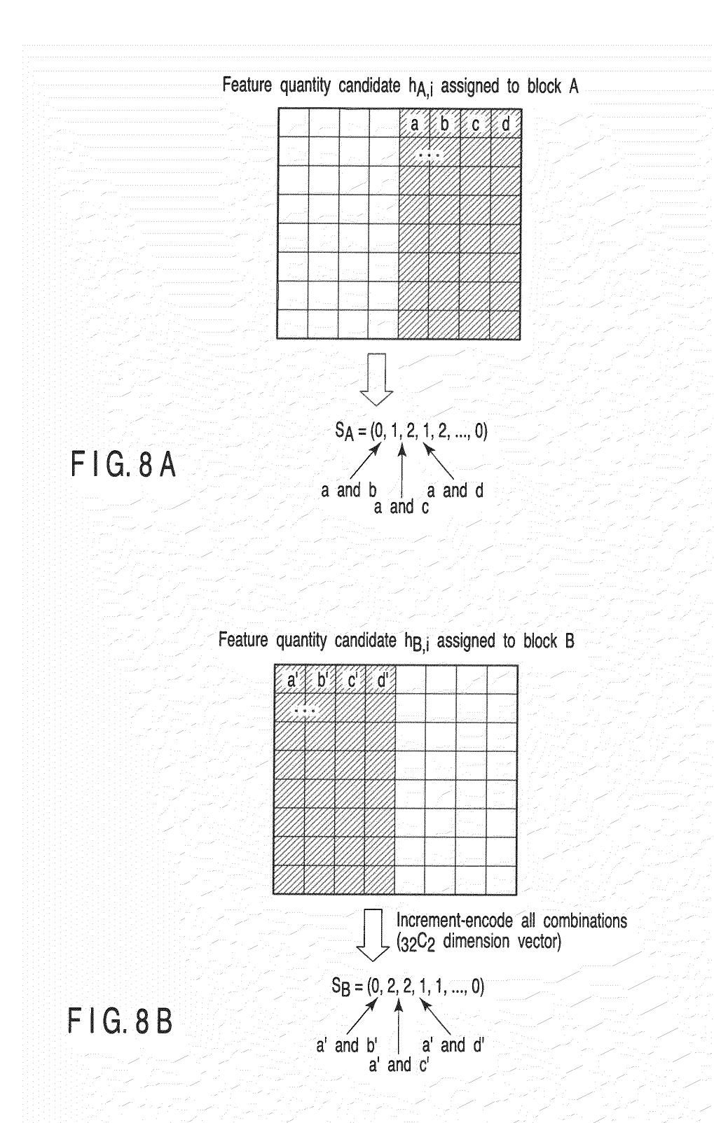

In order to calculate the adjacent energy, at first in step S34, increment sign vectors {s_{A,1}, s_{A,2}, . . . , s_{A,NA}} and {s_{B,1}, s_{B,2}, . . . , s_{B,NB}} are derived from the luminance of the overlapping region R about the feature quantity data {h_{A,1}, h_{A,2}, . . . , h_{A,NA}} and {h_{B,1}, h_{B,2}, . . . , h_{B,NB}} of the feature quantity candidates as shown FIGS. 8A and 8B. The increment signs of two pixels (luminance values of two pixels a and b are assumed to be Ia and Ib respectively) are obtained by, for example, the following equation (1).

$$s = \{ \begin{matrix}2 & if Ia - Ib \geq σ \\ 1 & if - σ < Ia - Ib < σ \\ 0 & if Ia - Ib \leq - σ\end{matrix} \qquad ( 1 )$$

where σ is a threshold for accepting that a difference between the luminance values Ia and Ib is effective.

Here, three symbols (0, 1, 2) are assigned to the difference between the luminance values Ia and Ib, but any number of symbols more than two can be assigned. Furthermore, the increment sign vector may be generated from the increment signs about all of 496 combinations of 32 pixels as shown in FIGS. 8A and 8B, but may be generated from the increment signs about some combinations. In other words, the number of dimensions of the increment sign vector may be less than 496 dimensions. For example, if the increment sign vector is obtained only from the pair of pixels adjacent to each other horizontally, the number of dimensions is 24.

If the increment sign vector is a vector capable of calculating the similarity between the spatial luminance patterns such as a vector expressing a luminance gradient or a vector expressing edge strength due to the Laplacian operator, they can be used. Furthermore, the increment sign vector may be derived from the image block improved in quality using the feature quantity. In other words, the increment sign vector may be derived from g+h where the feature quantity is h, and the block clipped from the temporal high quality image 111 is g.

The adjacency energy V_{A,B,i,j} representing a similarity between the feature quantity candidate h_{A,i} and the feature quantity candidate h_{B,j} is calculated about combinations of all feature quantity candidates assigned to the blocks A and B using the increment sign vector derived as described above (step S35). Concretely, a coincidence between the increment sign vectors s_{A,i} and s_{B,j} is calculated as the adjacent energy V_{A,B,i,j} by the equation (2), for example.

$${V}_{A , B , i , j} = {\sum }_{k = 1}^{496} \vert {s}_{A , i} ( k ) - {s}_{B , j} ( k ) \vert \qquad ( 2 )$$

where s_{A,i}(k) is the k-th component of the increment sign vector s_{A,i,} and s_{B,j(k)} is the k-th component of the increment sign vector s_{B,j}.

In the equation (2), the sum of absolute differences (SAD) between the increment sign vectors s_{A,i} and s_{B,j} is taken as a coincident degree between s_{A,i} and s_{B,j,} but the sum of squared differences (SSD) between the increment sign vectors s_{A,i} and s_{B,j} may be taken as a coincident degree as expressed by the equation (3).

$${V}_{A , B , i , j} = {\sum }_{k = 1}^{496} {( {s}_{A , i} ( k ) - {s}_{B , j} ( k ) )}^{2} \qquad ( 3 )$$

In addition, the coincident degree between s_{A,i} and s_{B,j} may be calculated using the number of coincidental signs of the increment sign vectors s_{A,i} and s_{B,j} as shown in the equation (4).

$${V}_{A , B , i , j} = 1 - \frac{1}{496} {\sum }_{k = 1}^{496} δ ( {s}_{A , i} ( k ) - {s}_{B , j} ( k ) ) \qquad ( 4 )$$

where δ(x) is a function indicating 1 when x=0 but the value of 0 in the case other than x=0. In other words, since the second item on the right side of the equation 4 is a value obtained by dividing the number of coincidental signs of s_{A, i} and s_{B, j} by the number of dimensions 496 of the increment sign vector, it expresses a similarity between the feature quantity candidate h_{A,i} and the feature quantity candidate h_{B,j} like the equations (3) and (4).

The adjacent energy V_{A,B,i,j} calculated using the increment sign vector in this way is a function decreasing as the similarity between the feature quantities h_{A,i} and h_{B,j} increases.

The adjacent energy V_{A,B,i,j} needs not to be expressed by one term as shown by the equations (3) and (4), but may be calculated by combination (weighted sum) of two or more terms as expressed by the following equation (5), for example.

$${V}_{A , B , i , j} = {\sum }_{k = 1}^{496} \vert {s}_{A , i} ( k ) - {s}_{B , j} ( k ) \vert + λ {\sum }_{m = 1}^{32} {( {h}_{A , i} ( {p}_{m} ) - {h}_{B , j} ( {g}_{m} ) )}^{2} \qquad ( 5 )$$

where λ is a relaxation parameter, and h_{A,i(pm)} and h_{B,j(pm)} are pixels arranged at the m-th identical pixel position in the overlapping region R when h_{A,i} and h_{B,j} overlap.

The first term on the right side of the equation (5) corresponds to SAD shown in the equation (3) and expresses the coincident degree between the increment signs about feature quantity candidates assigned to the blocks A and B of the overlapping region R. The second term on the right side of the equation (5) corresponds to SSD disclosed in W. T. Freeman, E. C. Pasztor, and O. T. Carmichael, “Learning low-level vision”, International Journal of Computer Vision, vol. 40, no. 1, pp. 25-47, 2000, the entire contents of which are incorporated herein by reference, and expresses the sum of squared difference of a difference between the luminance values of feature quantity candidates assigned to the blocks A and B of the overlapping region R. In the equation (5), the adjacent energy V_{A,B,i,j} is calculated by the weighted sum of the coincident degree of the first term and the sum of squared difference of the second term using the relaxation parameter λ as a weighting factor.

Because use of the adjacent energy V_{A,B,i,j} of the equation (5) makes it possible to suppress a large difference between the luminance and luminance in the second term while evaluating the similarity of the luminance patterns between the feature quantity candidates assigned to the blocks A and B of the overlapping region R in the first term, an effect of generating an image of a few artifactual noise is obtained.

The process of steps S31-S35 is repeated till it is determined in step S36 that all adjacent blocks have been processed, and the processing of the adjacency energy calculation region 104 is finished.

(About the Selector 105)

The processing of the selector 105 is explained hereinafter. In step S40 of FIG. 2, the combination of feature quantity candidates by which the adjacent energy calculated with the adjacent energy calculator 104 comes to be very small, preferably minimum is determined from the feature quantity candidates assigned to two adjacent blocks of the temporal high quality image 111, respectively, as mentioned above. The feature quantity of the combination is selected, and a feature quantity index 116 indicating the combination is output. The method for determining the combination can conceive (a) a method for optimizing the sum of adjacent energies locally, and (b) a method for optimizing the sum of adjacent energies globally or in units of a block.

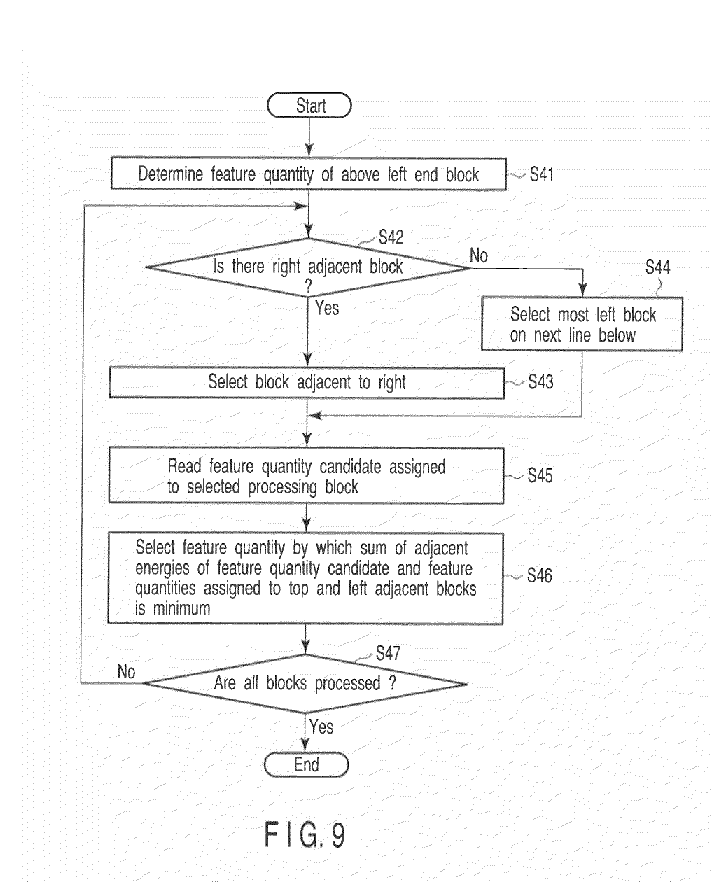

FIG. 9 illustrates an example of selecting the feature quantity by which the adjacent energy of the above method (a) is decreased locally, as the concrete process example of step S40 of FIG. 2. At first, the feature quantity of the left upper end block is determined (step S41). In other words, one feature quantity is selected from the feature quantity candidates assigned to the left upper end block. The feature quantity may be selected at random, and may be selected by the candidate indicating that the similarity based on ∥li-l_{query}∥ calculated with the feature quantity candidate assignment unit 103 is maximum.

Next, the block adjacent to the left upper end block on the right side is set as a processing block. In other words, it is examined whether there is a right adjacent block (step S42). If there is the right adjacent block, it is selected as the processing block (step S43). If there is no right adjacent block and the right-side end block of the image is arrived at in the middle of processing, the most left block of next line below is selected as a processing block (step S44).

An index of the feature quantity candidate assigned to the processing block selected in step S43 or S44 is read (step S45). From the feature candidates is selected the feature quantity by which the sum of the adjacent energy between the feature quantity candidate assigned to the processing block and the feature quantity assigned to the above adjacent block and the adjacent energy between the feature quantity candidate and the feature quantity assigned to the left adjacent block comes to be minimum. The selected feature quantity becomes the image quality improvement feature quantity for the processing block. At the time of step S46, the above adjacent block and left adjacent block are already processed for the processing block, and the feature quantities assigned to the upper adjacency block and left adjacency block are determined uniquely.

The process of steps S42-S46 is repeated till it is determined in step S47 that all adjacent blocks have been processed, and the processing of the selector 105 is finished.

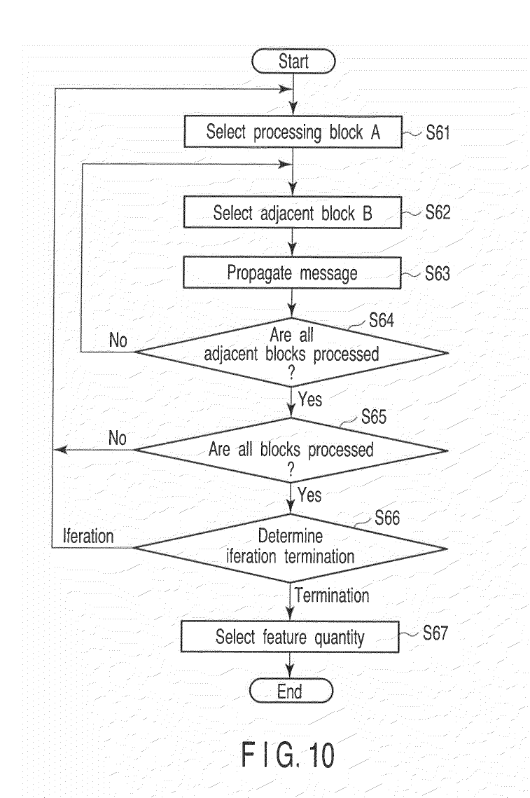

The optimization of the sum of adjacent energies V_{A,B,i,j} can be performed by using an optimization algorithm such as Belief Propagation. FIG. 10 illustrates an example of optimizing the sum of adjacent energies in the above method (b), as the concrete process of step S40 of FIG. 2.

At first, the processing block A is selected (step S51). Next, one block (adjacent block) B adjacent to the processing block A is selected (step S52). A message expressing reliability (conformity degree) is calculated by the following equation (6) for each candidate of the adjacent block B from the processing block A (step S53).

$${M}_{A \to B , j}^{( t )} = {min}_{i} {V}_{A , B , i , j} + {\sum }_{C ∈ Nei ( A ) \backslash B} {M}_{C \to A , i}^{( t - 1 )} \qquad ( 6 )$$

The left side of the equation (6) represents messages from the processing block A to the j-th candidate of the adjacent block B in the t-th iteration, and 0 is given to all messages as an initial value. Nei(A) indicates a set of the blocks adjacent to the processing block A. In other words, C in the equation (6) expresses a block except for the adjacency block B among the set of blocks adjacent to the processing block A.

Since the messages in the t-th iteration are calculated from the messages of another block calculated in the previous iteration, the messages propagate to all blocks in plural iterations. In addition, the propagated messages may be normalized by the following equation (7) so that the sum of the messages propagated from the processing block A to the adjacent block B becomes 0.

$${\overline{M}}_{A \to B , j}^{( t )} = {M}_{A \to B , j}^{( t )} - \frac{1}{{N}_{B}} {\sum }_{j = 1}^{{N}_{B}} {M}_{A \to B , j}^{( t )} \qquad ( 7 )$$

The left side of the equation (7) expresses normalized messages.

The operation of steps S52 and S53 is repeated till it is determined in step S54 that all blocks adjacent to the processing block A have been processed. Furthermore, the operation of steps S52-S54 is repeated till it is determined in step S55 that all blocks have been processed.

The process of steps S51-S55 is the iteration of one time. The iteration process of steps S51-S55 is done till a iteration stopping condition is satisfied in step S56. The iteration stopping condition can use a state that the number of iterations reaches a constant value or a state that magnitude relation of the values of all messages does not change. Finally, one feature quantity to be selected from candidates of each block is determined by the following equation (8), and the feature quantity is selected (step S57).

$${\hat{h}}_{A} = {h}_{A , \hat{i}} \\ \hat{i} = {arg min}_{i} {\sum }_{C ∈ Nei ( A )} {M}_{C \to A , i}^{( t )} \qquad ( 8 )$$

where h_{A} indicates the feature quantity to be selected.

(The Main Quality Improvement Unit 106)

The main quality improvement unit 106 improves quality of the temporal high quality image 111 by the feature quantity selected with the selector 105 and generates an output image 117. Since each block of the temporal high quality image 111 overlaps horizontally and vertically four pixels respectively, four feature quantities will be related to each pixel of the high quality output image 117. Therefore, the main quality improvement unit 106 calculates the luminance value of each pixel of the output image 117 by adding an average of the luminance values of four feature quantities to the luminance of the temporal high quality image 111.

### Second Embodiment

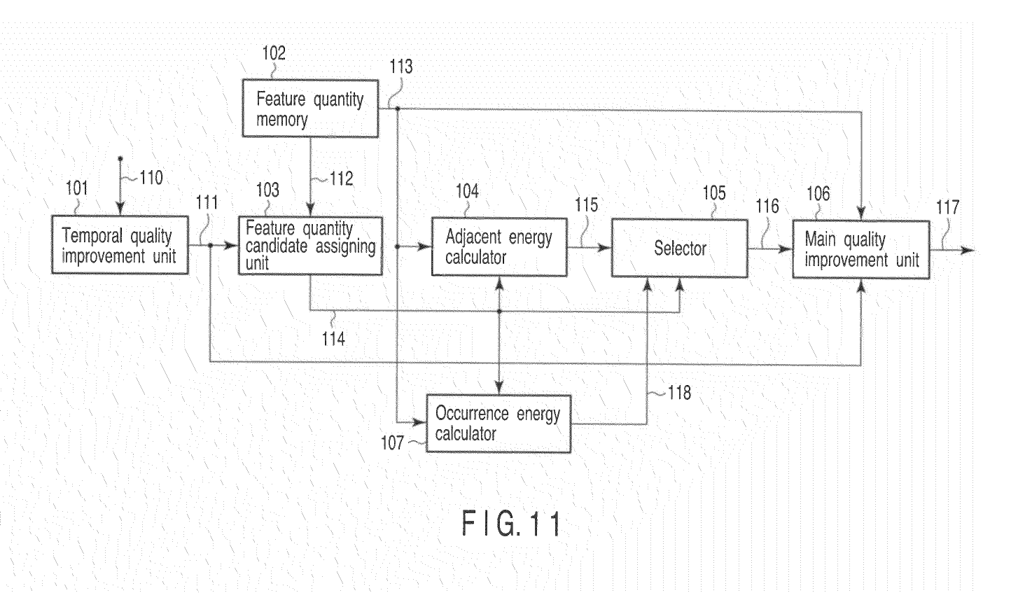

FIG. 11 shows an image quality improvement apparatus according to the second embodiment. An occurrence energy calculator 107 is added to the image quality improvement apparatus shown in FIG. 1 according to the first embodiment.

The first embodiment provides an example that the selector selects the feature quantity so that the adjacent energy is optimized. In contrast, in the second embodiment, the occurrence energy calculator 107 calculates an energy (called an occurrence energy) indicating a conformity degree to the input image 110 as the feature quantity candidate, separately. The selector 105 receives adjacent energy information 115 from the adjacent energy calculator 104 and occurrence energy information 118 from the occurrence energy calculator 107, and selects a feature quantity to optimize a weighted sum of the adjacency energy and the occurrence energy as expressed by the following equation (9).

$${\sum }_{A} {D}_{A , i} + μ {\sum }_{\{ A , b \} ∈ Ω} {V}_{A , B , i , j} \qquad ( 9 )$$

where μ is a relaxation parameter, and Ω is a set of all adjacent blocks. In addition, D_{A,i} is an occurrence energy defined about the feature quantity candidate h_{A,i}. In the expression (9), the weighted sum of the occurrence energy of the first term and the adjacent energy of the second term is calculated using the relaxation parameter μ as a weighting factor. The occurrence energy D_{A,i} is defined by the following equation (10).

D_{A,i}=∥l_{A,i}−l_{A,query}∥² (10)

where l_{A,i} is a low quality image feature quantity corresponding to h_{A,i} in the feature quantity memory 102, and l_{A,query} is the low quality image feature quantity extracted from the block A.

According to this embodiment, there is obtained an effect that a high frequency component suitable for the input image is selected so that a picture quality is improved or occurrence of artifactual noise is suppressed.

### EXAMPLE

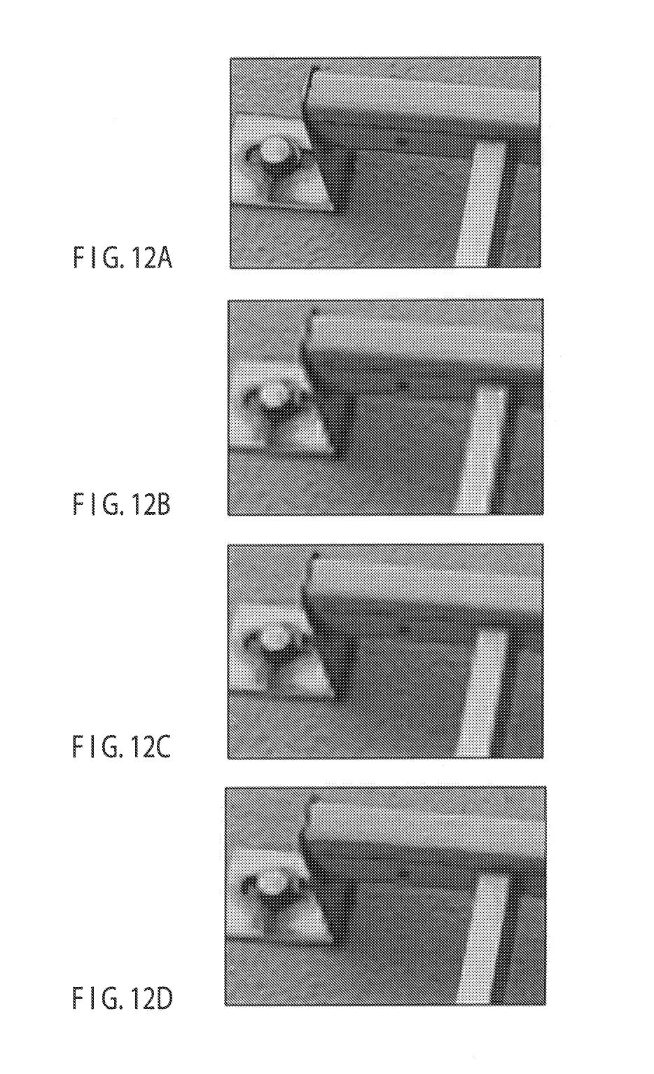

There is described a result that the high quality image is generated according to the first embodiment referring to FIGS. 12A, 12B, 12C and 12D. FIG. 12A shows an original image, and an input image 110 is generated artificially by reducing the width and height of the original image to ¼ times. The result obtained by improving the quality of the input image 110 by enlarging the width and height of the input image 110 to 4 times in size is shown in FIGS. 12B, 12C and 12D. FIGS. 12B, 12C and 12D show a high quality image obtained by using a conventional method (proposed by W. T. Freeman et. al), the temporal high quality image 111, and the output image 117, respectively.

As a condition of the experiments, the feature quantity for image quality improvement is assumed to be an image patch indicating a high frequency component which is not included in the temporal high quality image 111, and 16 feature quantity candidates are assigned to the blocks of the temporal high quality image 111, respectively. Belief Propagation is used for optimization of the adjacent energy in the selector 105.

When an error between each image of FIGS. 12B, 12C and 12D and the original image was measured by PSNR (Peak Signal to Noise Ratio), values 0f 31.6 dB, 30.6 dB and 32.1 dB was acquired. As understood from these results, the embodiment can generate an output image of sharper and higher quality than the output image of the prior art technique.

In this way, according to the image quality improvement apparatus according to each embodiment of this invention, an image of sharpness and high quality can be generated by evaluating the adjacency energy based on the similarity of the luminance patterns of the feature quantities.

In addition, the image quality improvement apparatus according to the embodiment of this invention can be realized even by using a general-purpose computer as basic hardware. In other words, the temporal quality improvement unit, the feature quantity candidate assigning unit, the adjacent energy calculator unit, the selector and the main quality improvement unit can be realized by letting a processor equipped with the computer mentioned above execute a program. In this time, the image quality improvement apparatus may be realized by installing in a computer the program mentioned above beforehand, or by distributing the above-mentioned program stored in a storage medium such as CD-ROM or transferred through a network and installing this program in a computer appropriately. In addition, the memory device uses a built-in memory or external memory for the computer, a hard disk or storage mediums such as CD-R, CD-RW, DVD-RAM, DVD-R appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for improving quality of an image comprising:
storing plural feature quantity candidates each having a luminance component for improving quality of a first image in a storage;
dividing the first image into plural blocks with an overlapping region being formed between a first block and a second block which are adjacent to each other;
assigning a set of first feature quantity candidates and a set of second feature quantity candidates which are selected from the plural feature quantity candidates of the storage, to the first block and the second block, respectively;
calculating an energy expressing each similarity between first luminance patterns of the first feature quantity candidates in the overlapping region and second luminance patterns of the second feature quantity candidates in the overlapping region;
selecting one first feature quantity and one second feature quantity from the first feature quantity candidates and the second feature quantity candidates, using the energy;
improving quality of the first block and the second block using the first feature quantity and the second feature quantity to generate a second image.

2. The method according to claim 1, wherein the feature quantity corresponds to a high frequency component of the image.

3. The method according to claim 1, wherein the selecting includes selecting the first feature quantity and the second feature quantity by which the energy comes to be very small, from the first feature quantity candidates and the second feature quantity candidates.

4. The method according to claim 1, which further includes calculating another energy representing a conformity degree of the first feature quantity candidates with respect to the first image and wherein the selecting includes selecting the first feature quantity and the second feature quantity by which a weighted sum of the energy and the another energy comes to be very small.

5. An image quality improvement apparatus comprising:
a memory to store plural feature quantity candidates each having a luminance component for improving quality of a first image;
an assigning unit configured to divide the first image into plural blocks with an overlapping region being formed between a first block and a second block which are adjacent to each other and assign a set of first feature quantity candidates and a set of second feature quantity candidates selected from the plural feature quantity candidates of the storage to the first block and the second block, respectively;
a calculator to calculate an energy expressing each similarity between first luminance patterns of the first feature quantity candidates in the overlapping region and second luminance patterns of the second feature quantity candidates in the overlapping region;
a selector to select one first feature quantity and one second feature quantity from the first feature quantity candidates and the second feature quantity candidates, using the energy;
a quality improvement unit configured to improve quality of the first block and the second block using the first feature quantity and the second feature quantity to generate a second image.

6. The apparatus according to claim 5, wherein the selector selects the first feature quantity and the second feature quantity by which the energy comes to be very small, from the first feature quantity candidates and the second feature quantity candidates.

7. The apparatus according to claim 5, which further includes a calculator to calculate another energy representing a conformity degree of the first feature quantity candidates with respect to the first image and wherein the selector selects the first feature quantity and the second feature quantity by which a weighted sum of the energy and the another energy comes to be very small.

8. The apparatus according to claim 5, wherein the energy calculator calculates as the energy a coincident degree between first increment signs about the first feature quantity candidate in the overlapping region and second increment signs about the second feature quantity candidate in the overlapping region.

9. The apparatus according to claim 5, wherein the energy calculator calculates a coincident degree between first increment signs about the first feature quantity candidate in the overlapping region and second increment signs about the second feature quantity candidate in the overlapping region and a sum of squared differences between first luminance values of the first feature quantity candidate in the overlapping region and second luminance values of the second feature quantity candidate in the overlapping region, and calculates a weighted sum of the coincident degree and the sum of squared differences as the energy.

10. The apparatus according to claim 5, wherein the energy calculator calculates first increment signs about combinations of all pixels of the first feature quantity candidates in the overlapping region and second increment signs about combinations of all pixels of the second feature quantity candidate in the overlapping region.

11. The apparatus according to claim 5, wherein the energy calculator calculates first increment signs about combinations of some pixels of the first feature quantity candidate in the overlapping region and second increment signs about combinations of some pixels of the second feature quantity candidate in the overlapping region.

12. The apparatus according to claim 8, wherein the energy calculator calculates the first increment sign by assigning two or more kinds of symbols to a luminance difference between two pixels of the first feature quantity candidate in the overlapping region and calculates the second increment sign by assigning two or more kinds of symbols to a luminance difference between two pixels of the second feature quantity candidate in the overlapping region.

13. The apparatus according to claim 5, wherein the selector selects a combination of the feature quantities by which a sum of first energies calculated by combinations of all first blocks and all second blocks comes to be very small.
